(19) United States
(12) Patent Application Publication
(10) Pub. No.: US 2012/0090319 A1
(43) Pub. Date: Apr. 19, 2012

(54) COMPOUNDED DILUTION AND AIR CHARGING DEVICE

(75) Inventors: Alan Mond, Ann Arbor, MI (US); Aristotelis Babajimopoulos, Ann Arbor, MI (US); Prasad Sunand Shingne, Ann Arbor, MI (US); Hakan Yilmaz, Ann Arbor, MI (US); Dionissios Assanis, Ann Arbor, MI (US)

(73) Assignee: ROBERT BOSCH GMBH, Stuttgart (DE)

(21) Appl. No.: 13/336,220

(22) Filed: Dec. 23, 2011

Related U.S. Application Data
(60) Provisional application No. 61/477,878, filed on Apr. 21, 2011.

(51) Int. Cl. F02B 37/16

(52) U.S. Cl. 60/609

(57) ABSTRACT

An internal combustion engine includes a turbocharger and a selectively operable positive displacement supercharger downstream of the turbocharger in the intake path. An input shaft of the supercharger is mechanically coupled to and driven by a piston-driven crankshaft. A bypass valve is configured to selectively bypass at least a portion of the air from the turbocharger air outlet around the supercharger. Power and fuel consumption are optimized by operating the supercharger to dilute the fuel-air mixture to achieve an excess air factor λ above 1.0, and in some cases above the upper range (λ=1.3) of normal stoichiometric operation. The engine can operate in a lean low temperature combustion mode (e.g., HCCI) with the supercharger operating, and in a stoichiometric spark ignition combustion mode with the supercharger bypassed.

### CROSS-REFERENCE TO RELATED APPLICATIONS

This invention is a non-provisional of U.S. Provisional Patent Application No. 61/477,878, filed Apr. 21, 2011, the entire contents of which is hereby incorporated by reference.

### STATEMENT REGARDING FEDERALLY SPONSORED RESEARCH AND DEVELOPMENT

This invention was made with Government support under contract DE-EE0003533 awarded by the Department of Energy. The Government has certain rights in this invention.

### BACKGROUND

The present invention relates to internal combustion engines.

Homogeneous Charge Compression Ignition (HCCI) has been a topic of widespread research due to its potential of reducing in-cylinder NOₓ and particulate emissions while maintaining high thermal efficiency.

The HCCI combustion process involves the induction of a premixed (homogeneous) fuel-air mixture along with diluents at equivalence ratios varying from very lean to stoichiometric. Once within the cylinder, the mixture is compressed until auto-ignition initiates, ideally just after top dead center (TDC). The ignition is followed by the combustion event which is very rapid and the heat is released within a few crank angle (CA) degrees, as fast as 5 CA degrees. HCCI combustion engines show promise in combining the advantages of homogeneous spark ignition (SI) combustion and stratified compression ignition (CI) combustion like conventional diesel, while eliminating their drawbacks. Due to the lean and homogeneous operation, the peak in cylinder temperatures are lowered and fuel rich zones are negligible in number. This leads to reduced NOₓ and particulate emission. Additionally the lean mixtures improve the thermal efficiency due to lower ratios of specific heats, and unthrottled operation reduces the pumping losses significantly.

HCCI operation is generally limited to low and medium loads due to maximum pressure rise rates which become unacceptable with increasing fueling rates. Intake charge boosting has been researched for over a decade to increase the high load limit of HCCI engines. Initial work was done at the Lund University but studies with gasoline fuel were limited. Recent studies have shown that loads of up to 16 bar gross indicated mean effective pressure (IMEP) were successfully achieved with intake boosting of about 3 bar. However, boost was provided by external compressors, engines had a high geometric compression ratio (14:1), valves were unmodified, combustion timing was controlled with intake air temperature control, and there was almost no dilution due to burnt residuals. Johansson et al. “HCCI Operating Range in a Turbo-charged Multi Cylinder Engine with VVT and Spray-Guided DI,” SAE 2009-01-0494, performed studies on engines with more “production like” configurations, namely compression ratios of 11:1 to 12.5:1 and low lift cams with variable valve actuation (VVA). They performed experiments with “simulated” turbocharging (i.e., providing intake boost from externally driven compressors and imposing external back pressure by assuming appropriate turbocharger efficiencies) with a 10 bar brake mean effective pressure (BMEP) reported at 1000 rpm. Another boosting study with a BorgWarner BV 35 turbocharger achieved 6.5 bar net IMEP at 1000 rpm.

Recent simulation studies also report similar trends. Kulzer et al., “A Thermodynamic Study on Turbocharged HCCI: Motivation, Analysis and Potential,” SAE Int. J. Engines, 3(3)733-749, 2010, reported 8 bar BMEP at 2000 rpm with thermodynamic work cycle simulation on a 2 L engine equipped with VVA and a geometric compression ratio of 10.5:1. Simulation studies at the University of Michigan, Ann Arbor also reported significant improvement in the maximum load achievable by boosting HCCI. Mamalis et al., “Comparison of Different Boosting Strategies for Homogeneous Charging Compression Ignition Engine—A Modeling Study,” SAE Int. J. Engines, 3(3):296-308, performed an exhaustive study comparing supercharged, turbocharged and two-stage turbocharged configurations at 2000 rpm. BMEP of 7 bar was reported as the maximum load achieved by the two-stage turbocharged system. Shingne et al., “Turbocharger Matching for a 4-Cylinder Gasoline HCCI Engine Using a 1D Engine Simulation”, SAE, 2010-01-2143, performed boosting studies with stock “off-the-shelf” BorgWarner turbocharger maps and compared single and two-stage turbocharged HCCI performance at high load for engine speeds from 1000 rpm to 4000 rpm. Maximum load of about 10 bar BMEP was achieved at 2500 rpm with a BorgWarner VTG BV 35 turbocharger as the high pressure stage.

From these studies, requirements for boosted HCCI turbomachinery have become clear over time. Typically, boosted HCCI operation demands higher boost compared to conventional engines due to higher dilution required by the NOₓ limit. Intake boost for turbocharged HCCI comes at a significant pumping loss penalty of about 2 bar to 3 bar if an intake boost of up to 2.8 bar absolute is desired. This is due to low exhaust gas enthalpies, which is a characteristic of HCCI.

A small single-stage turbocharger can theoretically be used to extend the range of HCCI (Homogenous Charge Compression Ignition) operation. However, a small turbocharger exerts high backpressure on the exhaust manifold, increasing pumping losses and reducing overall efficiency.

Superchargers are typically less efficient than comparable turbochargers since the friction losses are more than pumping losses of a comparable turbocharger for conventional engines. However, turbocharged HCCI suffers high pumping losses especially at high load/boost conditions and the efficiency of the supercharged configuration approaches the turbocharged configuration at these conditions. Gharahbaghi et al., “Modelling and Experimental Investigations of Supercharged HCCI Engines”, SAE 2006-01-0634, performed a modeling and experimental study on supercharged HCCI and suggested the use of smaller superchargers with moderate boost to offset the fuel economy penalty.

One known approach including a combined Supercharger-Turbocharger configuration is Volkswagen's “Twincharger” wherein the outlet of the supercharger feeds into the inlet of the turbocharger compressor. The purpose of this device is to reduce the so-called “turbo-lag” present in a turbocharged engine by improving low-end torque via supercharger boost when off-idle acceleration is demanded. This prior device/concept is not related to Homogenous Charge Compression Ignition operation or advanced lean/low temperature combustion of any type, but rather stoichiometric spark ignition combustion. Furthermore, the addition of the supercharger does not have a positive net effect on fuel economy.

Another known approach including a combined Supercharger-Turbocharger configuration is disclosed in UK Patent Application GB 2420152 of Lotus Cars Limited. In this configuration, which is described as being operable in controlled auto-ignition/HCCI combustion, intake air is compressed in a supercharger before being further compressed in a turbocharger and then run through an intercooler and an expander to reduce temperature and pressure before delivery to the cylinders. This design appears to attempt offsetting the inefficiency associated with the supercharger by taking energy from the expander and applying it back to the engine's crankshaft.

In view of the prior art as a whole, a commercially viable alternative combustion engine offering extended load range and maximum fuel economy with simplicity in design and operation is still needed.

### SUMMARY

In one aspect, the invention provides an internal combustion engine. The engine includes at least one cylinder including a cylinder intake, a cylinder exhaust, and a piston. The engine further includes a turbocharger and a positive displacement supercharger. The turbocharger has a turbine inlet fluidly connected to the cylinder exhaust, a turbocharger compressor inlet, and a turbocharger compressor outlet. The positive displacement supercharger has a supercharger inlet fluidly connected to the turbocharger compressor outlet and a supercharger outlet that is fluidly connected to the cylinder intake. An input shaft of the positive displacement supercharger is mechanically coupled to and driven by a crankshaft that is rotated by the piston. A bypass valve is configured to selectively bypass at least a portion of the flow from the turbocharger compressor outlet around the positive displacement supercharger. The bypass valve is positioned in a bypass passage having a bypass inlet fluidly connected to the turbocharger compressor outlet and a bypass outlet fluidly connected to the cylinder intake.

In another aspect, the invention provides a method of operating an internal combustion engine. Air flows into a cylinder through a cylinder intake. Exhaust gas flows from a cylinder exhaust to a waste inlet of a turbocharger. A positive displacement supercharger is provided between an air outlet of the turbocharger and the cylinder intake, and a bypass valve is provided in parallel with the positive displacement supercharger. An input shaft of the positive displacement supercharger is driven through a mechanical driving connection with a crankshaft that is rotated by a piston movable in the cylinder. Ambient air is provided to an air inlet of the turbocharger, and the air is compressed in the turbocharger to a first pressure above ambient. The air is provided at the first pressure to an inlet of the positive displacement supercharger. The air received at the inlet of the positive displacement supercharger is compressed with the bypass valve at least partially closed. Air is supplied from an outlet of the positive displacement supercharger to the cylinder intake at a second pressure higher than the first pressure. The air at the second pressure is admitted into the cylinder, fuel is supplied to the cylinder, and the air and the fuel are compressed with the piston. The air and the fuel are combusted to release power to the piston and the crankshaft. An excess air factor is manipulated by controlling the position of the bypass valve.

Other aspects of the invention will become apparent by consideration of the detailed description and accompanying drawings.

### BRIEF DESCRIPTION OF THE DRAWINGS

FIG. 1 is a schematic diagram of an internal combustion engine according to one aspect of the invention.

FIG. 2 is a schematic diagram of a control system of the internal combustion engine of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

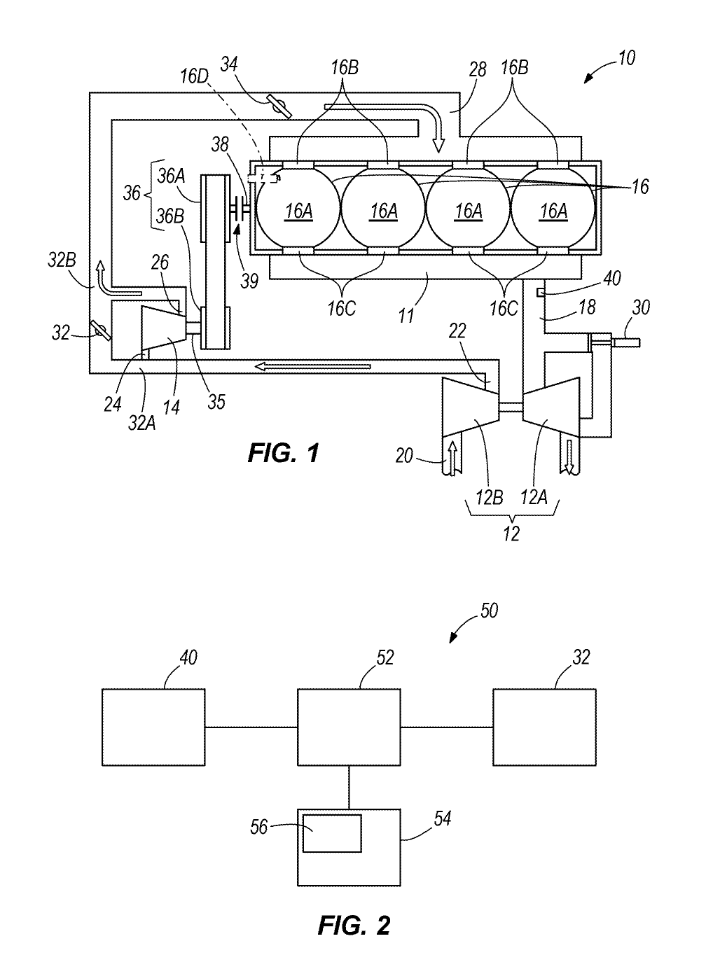

FIG. 1 depicts an internal combustion engine 10. In some embodiments, the engine 10 is configured to operate with homogeneous charge compression ignition (HCCI) in at least a portion of an operating range. In HCCI operation, fuel (e.g., gasoline or diesel) and air auto-ignite without a spark, and excess air factor λ may be between about 1.5 and about 2.0 (i.e., entirely above the range of normal stoichiometric operation). It is also contemplated that the engine 10 may operate without HCCI in another portion of the operating range (e.g., stoichiometric spark ignition with excess air factor λ around 1.0 (e.g., between 0.7 and 1.3)). In other embodiments, the engine can be configured to operate with another type of low temperature and/or lean (not stoichiometric SI) combustion other than HCCI. Without limitation, these can include stratified compression ignition or diesel combustion, lean spray-guided direct injection combustion with spark ignition, reactivity controlled compression ignition with multiple fuels, and lean spark ignition, all of which are “non-stoichiometric”—capable of normal operation entirely maintained leaner than stoichiometric (excess air factor λ staying continuously over 1.0), and/or normal operation that exceeds the upper range (λ=1.3) of normal stoichiometric operation. Moreover, while the engine 10 can be configured to operate on one or more petroleum based fuels, the engine 10 in other embodiments may be configured to operate, in addition to or instead of petroleum based fuel, on one or more non-petroleum based fuels (e.g., ethanol or blends, including but not limited to E100 and E85, biofuels, etc.).

The engine 10 includes a turbocharger 12, a supercharger 14, and at least one cylinder 16 (e.g., an in-line four cylinder engine in the illustrated embodiment). It will be understood by one of ordinary skill in the art that each cylinder 16 houses a movable piston 16A configured to compress an intake charge of air and fuel mixture and transfer the energy of combustion to a crankshaft 38 coupled to all of the pistons 16A. A valvetrain is provided including an intake valve 16B and an exhaust valve 16C for respectively controlling the inlet and exhaust of gases into and out of each cylinder 16. The valvetrain can be configured to provide variable opening amount and timing of one or both of the intake 16B and exhaust valves 16C. Although fuel and air may be combusted without any spark in some or all operational modes in some constructions of the engine 10, at least one spark plug 16D may be positioned in each cylinder 16 and configured to create an electrical spark for initiating combustion events in some or all operational modes of some constructions of the engine 10. To keep FIG. 1 as tidy as possible, only one spark plug 16D is illustrated.

The turbine side 12A of the turbocharger 12 is driven by exhaust expelled from the cylinders 16 through a cylinder exhaust (e.g., manifold) 11 to a turbocharger turbine inlet 18. The compressor side 12B of the turbocharger 12 includes a compressor, a turbocharger air inlet or compressor inlet 20, and a turbocharger air outlet or compressor outlet 22. As exhaust energy drives the turbine of the turbocharger 12, the compressor, which is drivably coupled to the turbine (e.g., on a common shaft) is rotated to boost the pressure of the intake air from the compressor inlet 20 to the compressor outlet 22. As known to those of skill in the art, the increased intake pressure enables the engine 10 to generate power and torque similar to a naturally aspirated engine of larger displacement with greater efficiency. Exhaust flow through the turbine side 12A of the turbocharger 12 corresponds to exhaust pressure available from the cylinder exhaust 11, but is limited to a predetermined maximum by a waste gate 30.

The turbocharger compressor outlet 22 is in fluid communication with a supercharger air inlet 24. A supercharger air outlet 26 is in fluid communication with a cylinder intake (e.g., manifold) 28. A bypass valve 32 positioned in parallel with the supercharger 14 controls the flow of intake air through the supercharger 14 (i.e., air flows through the supercharger 14 when the bypass valve 32 is closed, and bypasses the supercharger 14 when the bypass valve 32 is open). The bypass valve 32 is a variable position throttle valve in some constructions. The bypass valve 32 is positioned in a passage having a bypass inlet 32A fluidly connected to the turbocharger compressor outlet 22 and a bypass outlet 32B fluidly connected to the cylinder intake 28. Although not shown in FIG. 1, an intercooler may be provided adjacent the supercharger air outlet 26 to cool the compressed air before induction into the cylinders 16 of the engine 10. Another variable-position throttle valve 34 is positioned between the supercharger 14 and the cylinder intake 28. The throttle valve 34 can be the engine's conventional throttle for controlling engine load during periods when the engine operates with spark ignition (non-HCCI) combustion.

The supercharger 14 is a positive displacement type supercharger (e.g., a roots-type supercharger) driven by the crankshaft 38. In some constructions, the supercharger 14 includes one of the EATON M24 supercharger and the new generation EATON TVS R410 supercharger. In the illustrated construction, an input shaft 35 the supercharger 14 is driven through a pulley and belt system 36 coupled to the crankshaft 38. The pulley and belt system 36 can include a crankshaft pulley 36A, a supercharger pulley 36B, and a belt wrapped around the two pulleys 36A, 36B. As discussed in further detail below, the effective drive ratio between the supercharger input shaft 35 and the crankshaft 38 is between about 1.9:1 and about 3.5:1. For example, in one construction the effective drive ratio can be about 2.4:1 (e.g., the supercharger input shaft 35 will spin at only about 6000 rpm at an engine speed of 2500 rpm). As discussed in further detail below, the supercharger 14 may only operate up to a predetermined threshold engine speed (e.g., about 3500 rpm). Thus, the supercharger 14 may be configured to only operate at speeds under 10,000 rpm or another corresponding threshold significantly lower than conventional supercharger operating speeds. In some constructions, the crankshaft pulley 36A is configured to rotate synchronously with the crankshaft 38, and the supercharger pulley 36B is configured to rotate synchronously with the supercharger input shaft 35, such that the effective drive ratio between the supercharger input shaft 35 and the crankshaft 38 is simply the diameter ratio or “pulley ratio” between the crankshaft pulley 36A and the supercharger pulley 36B. In other constructions one or more additional speed-changing transmission devices may be provided between the crankshaft 38 and the supercharger input shaft 35.

A control system 50 which is part of the engine 10 or engine system is depicted in FIG. 2. The engine control system 50 includes a processor 52 and a memory 54. Command instructions 56 are stored in the memory 54. The processor 52 is operably connected to the memory 54, the supercharger bypass valve 32, and at least one sensor 40. The processor 52 is configured to receive a signal from the sensor 40 and to execute corresponding command instructions 56 to control the bypass valve 32. In some embodiments, the at least one sensor 40 includes at least one exhaust gas sensor which determines from the combustion products the current air/fuel ratio (or excess air factor λ) of the combustion occurring within the engine 10, and the bypass valve 32 is increasingly closed in conjunction with a demand to increase the excess air factor, up to a point where the bypass valve 32 is completely closed and all of the air from the turbocharger air outlet 22 is directed through the supercharger 14. In some embodiments, the control system 50 can include a sensor positioned between the supercharger 14 and the cylinders 16 configured to send a signal to the processor 52 indicative of mass air flow rate, and this information can be used in lieu of or in addition to signals indicative of exhaust gas contents to determine current excess air factor λ, and how to control the bypass valve 32 to achieve a target excess air factor λ. In some constructions, the processor 52 is configured to maintain the bypass valve 32 in the open position from idle engine speed up to a predetermined threshold engine speed (e.g., about 1500 rpm), above which the bypass valve 32 is moved toward the closed position and manipulated in an at least partially closed position. The fuel rate is controlled (by the processor 52 or another processor of the engine control system 50) to manage the overall output of the engine 10 in response to driver demand. Fuel can be delivered via direct injection into each the cylinders 16 by one or more fuel injectors (not shown).

Although studies have suggested forced induction (or “boosting”) to extend the high load limit of HCCI combustion—to maximize the benefits of HCCI throughout a fuller portion of the engine's operating range—the boosting strategy of the present invention represents a significant advance from any previously conceived boosting strategy for an HCCI engine or other type of low temperature or lean combustion engine. The engine 10 of the present invention is developed as a commercially viable package that demonstrates the emissions advantages of low temperature lean combustion, such as HCCI combustion, over an extended range, and provides even further reduction in fuel consumption over known boosted-HCCI engines. Turbochargers are generally known to provide better fuel economy compared to superchargers of similar boosting capability. However, as discussed above, turbochargers rely on the energy of the exhaust gas to produce boost. Therefore, a large turbocharger which produces adequate boosting for the high load spark ignition operation of a small engine may produce very minimal or no boost during HCCI operation where exhaust gas enthalpy is very low. Thus, a series two-stage boosting system is preferred.

With the object of minimizing fuel consumption of the engine 10, one of ordinary skill in the art would generally contemplate adding a second turbocharger (e.g., a small turbocharger configured to provide boost with lower available exhaust energy). However, if a small turbocharger is provided as the second stage boosting device, the turbocharger necessarily exerts high backpressure that increases pumping losses. In the engine 10 of the present invention, the supercharger 14 is provided as the second stage boosting device (i.e., the high pressure stage boosting device downstream of the turbocharger 12). Because the supercharger 14 is provided to aid HCCI operation by pumping excess intake air into the engine 10, maximum boost pressure is not necessarily the prime objective of the supercharger 14. Rather, mass air flow is the key parameter. In this respect, the use of the supercharger 14 has actually been found to produce the requisite air mass flow more efficiently than a comparable turbocharger. For example, testing has shown that when the amount of fresh charge (mass air flow rate) is matched for both the turbocharged-supercharged (TCSC) engine 10 of the invention and an identical engine having the supercharger 14 replaced by a small turbocharger, the TCSC engine 10 demonstrates significant advantage (up to about 4 percent improvement) in brake specific fuel consumption for high load points (˜6.5 bar BMEP) over a significant range of engine speeds above a lower limit engine speed near idle (e.g., 1500 rpm) (see Shingne et al., “Assessment of Series Two-Stage Boosting Systems for a Gasoline HCCI Engine Using a 1-D Engine System Simulation”, ICEF2011-60220, which is incorporated by reference herein, both directly and by way of inclusion in U.S. Provisional Patent Application No. 61/477,878, which is also incorporated by reference herein).

Despite being driven with power taken from the engine's crankshaft 38, the supercharger 14 manages to more efficiently develop a predetermined mass air flow rate for diluting HCCI combustion. This appears to be due to the fact that a second stage turbocharger introduces increased pumping losses during HCCI operation. Despite being able to provide even higher intake pressure than the supercharger 14, a second stage turbocharger capable of providing the predetermined mass air flow rate equivalent to the TCSC engine 10 necessarily induces exhaust backpressure that significantly hampers the ability to empty the cylinders 16 and recharge with fresh air. In contrast, the supercharger 14 has no such impact on the exhaust backpressure, and by being placed downstream of the turbocharger 12 has its operational pressure ratio (between a predetermined outlet pressure at the supercharger air outlet 26 and a pressure of air supplied to the supercharger air inlet 24) reduced. Further improving the pressure ratio for the supercharger 14 is that, in the absence of a second turbocharger, all of the exhaust gas flow is available to drive the one turbocharger 12. In effect, the turbocharger 12 acts as a low pressure or “first stage” boosting device to raise the pressure of ambient air to a first pressure above ambient and supply air at the first pressure to the supercharger air inlet 24. The supercharger 14 then has less work to do to supply air at the predetermined outlet pressure. This means that less energy is taken from the crankshaft 38 than if the supercharger inlet 24 were exposed to ambient.

The overall result, which is contrary to conventional wisdom to those of skill in the art, is that the use of the supercharger 14 as a high pressure stage boosting device downstream of the turbocharger 12 is more fuel efficient than replacing the supercharger 14 with a turbocharger. As an added benefit, controlling the mass air flow rate into the cylinder intake 28 is made simple, efficient, and predictable by manipulating the position of the supercharger bypass valve 32 and keeping the throttle valve 34 completely open. This takes maximum advantage of the bypass valve 32, which is already present to turn the supercharger 14 “on” and “off”, and the effects are direct and predictable since the delivery of air from the supercharger 14 to the cylinder intake 28 varies simply as a function of operational speed.

Furthermore, the inventors have found that within the framework of the illustrated engine 10, the supercharger 14 can produce the necessary mass air flow for HCCI operation with very low running speeds. Whereas a typical supercharger in an internal combustion engine may operate with an effective drive ratio of 4:1 or more, the supercharger 14 can be effectively operated with an effective drive ratio of only about 3.5:1 or less, or even about 3.0:1 or less (e.g., about 2.4:1 in one example). This further reduces frictional losses associated with driving the supercharger 14 through the pulley system 36. The pulley system 36 can also be a clutched pulley system configured to selectively decouple the mechanical connection between the crankshaft 38 and the supercharger 14 (e.g., outside the HCCI operating range, during high load spark ignition combustion for maximum power). In one embodiment, an electromagnetic computer-controlled clutch 39 is positioned between the crankshaft 38 and the crankshaft pulley 36A. The clutch 39 can be electronically actuated (e.g., by the processor 52) to disengage at a predetermined threshold engine speed (e.g., about 3500 rpm), above which the supercharger's efficiency advantage is no longer realized. Above this engine speed, the turbocharger 12 operates efficiently to provide compressed air to the cylinder intake 28. In lieu of the basic pulley system 36, other options for driving the supercharger 14 include a planetary gear transmission or a continuously variable transmission (CVT).

Another advantage of the TCSC engine 10 of FIG. 1 over a similar engine utilizing series turbochargers is higher pre-catalyst exhaust temperatures, making it more favorable in terms of catalyst warm up.

Thus, the embodiments incorporate a low pressure stage turbocharger, where the turbocharger's compressor outlet feeds into the supercharger inlet and the supercharger then delivers the compounded air charge into the intake manifold. Superchargers on their own are typically less efficient than turbochargers since the friction losses are usually higher than the pumping losses on a turbocharger. However turbocharged HCCI suffers high pumping losses especially at the upper boundary of high load HCCI operation. Therefore combining a low pressure turbocharger with the compressor side outlet being coupled to the inlet of a supercharger to provide compressed air reduces the mechanical/frictional losses on the supercharger and also diminishes pumping losses.

Accordingly, the present disclosure includes a configuration that provides increased fuel efficiency in a low temperature and/or lean combustion engines. Although portions of the above description focus on an HCCI engine as one type of low temperature lean combustion engine that achieves a significant benefit from the invention, those of skill in the art will realize that the description herein may also be adapted to other types of advanced combustion (i.e., low temperature and/or lean combustion rather than conventional stoichiometric spark ignition). For example, a lean spray-guided direct injection engine constructed and operated according to the above description may be particularly advantageous for enabling lean operation without the need for NOₓ after-treatment (i.e., a “lean NOₓ trap”) which is presently needed with lean spray-guided direct injection to meet emissions, but at a high cost. In addition, the engine configuration and method of operation described above can be beneficial in a transitional hybrid combustion mode such as spark assisted compression ignition (SACI) in which a spark is used to help initiate a compression ignition combustion event. The present disclosure further provides a configuration that can be incorporated into a non-petroleum fuel based combustion engine.

It should also be appreciated that the engine and method of operating disclosed herein is not limited to combusting fuel with ambient air. It is contemplated that exhaust gas recirculation (EGR) may be utilized so that residual exhaust gases are either retained in the cylinders after combustion (internal EGR), or returned from a downstream exhaust passage (external EGR), for further combustion. Furthermore, it is conceived that an engine as described above can be operated by supplying combustion products (i.e., exhaust gas) from another engine, or any other combustible gaseous mixture, either with or without any additional fresh intake air.

Various features and advantages of the invention are set forth in the following claims.

What is claimed is:

1. An internal combustion engine comprising:
at least one cylinder including a cylinder intake, a cylinder exhaust, and a piston;
a turbocharger having a turbine inlet that is fluidly connected to the cylinder exhaust, a compressor inlet, and a compressor outlet;
a positive displacement supercharger having a supercharger inlet that is fluidly connected to the turbocharger compressor outlet and a supercharger outlet that is fluidly connected to the cylinder intake, an input shaft of the positive displacement supercharger being mechanically coupled to and driven by a crankshaft that is rotated by the piston; and
a bypass valve configured to selectively bypass at least a portion of flow from the turbocharger compressor outlet around the positive displacement supercharger, the bypass valve being positioned in a bypass passage having a bypass inlet that is fluidly connected to the turbocharger compressor outlet and a bypass outlet that is fluidly connected to the cylinder intake.

2. The internal combustion engine of claim 1, wherein the positive displacement supercharger is mechanically coupled to the crankshaft via a crankshaft pulley and a supercharger pulley, and wherein the effective drive ratio between the crankshaft and the input shaft of the positive displacement supercharger is less than about 3.5:1.

3. The internal combustion engine of claim 1, wherein the internal combustion engine is configured to maintain an excess air factor λ above 1.0 whenever the supercharger is operated.

4. The internal combustion engine of claim 1, wherein the positive displacement supercharger is a roots-type supercharger.

5. The internal combustion engine of claim 1, wherein the bypass valve is movable between an open position configured to direct substantially all of the flow from the turbocharger compressor outlet around and not through the positive displacement supercharger, and a closed position configured to direct substantially all of the flow from the turbocharger compressor outlet through the positive displacement supercharger.

6. The internal combustion engine of claim 5, wherein the bypass valve is variably positionable between the open position and the closed position.

7. The internal combustion engine of claim 6, further comprising a control system including a memory with command instructions stored therein, and a processor operably connected to the memory, the bypass valve, and to a sensor configured to provide a signal indicative of a measured excess air factor, the processor configured to execute the command instructions to move the bypass valve toward the closed position when the measured excess air factor is below a target excess air factor.

8. The internal combustion engine of claim 7, wherein the processor is configured to maintain the bypass valve in the open position from idle up to a threshold engine speed.

9. The internal combustion engine of claim 1, wherein the positive displacement supercharger is mechanically coupled to the crankshaft through a clutch configured to selectively decouple the positive displacement supercharger from the crankshaft above a predetermined engine speed.

10. The internal combustion engine of claim 1, further comprising at least one spark plug positioned in the at least one cylinder, the at least one spark plug configured to generate an electrical spark during a spark ignition cycle in the engine.

11. The internal combustion engine of claim 1, wherein the engine is a diesel engine.

12. The internal combustion engine of claim 1, wherein the engine is a homogeneous charge compression ignition (HCCI) engine.

13. The internal combustion engine of claim 1, wherein the engine is a lean spray-guided direct injection engine.

14. The internal combustion engine of claim 1, further comprising a valvetrain including an intake valve and an exhaust valve for respectively controlling the inlet and exhaust of gases into and out of the at least one cylinder, wherein the valvetrain is configured to provide variable opening amount and timing of at least one of the intake and exhaust valves.

15. A method of operating an internal combustion engine, the method comprising:
flowing air into a cylinder through a cylinder intake;
flowing exhaust gas from a cylinder exhaust to a waste inlet of a turbocharger;
providing a positive displacement supercharger between an air outlet of the turbocharger and the cylinder intake, and providing a bypass valve in parallel with the positive displacement supercharger;
driving an input shaft of the positive displacement supercharger through a mechanical driving connection with a crankshaft that is rotated by a piston movable in the cylinder;
providing ambient air to an air inlet of the turbocharger, compressing the air in the turbocharger to a first pressure above ambient, and providing the air at the first pressure to an inlet of the positive displacement supercharger;
receiving the air at an inlet of the positive displacement supercharger at the first pressure, compressing the air in the positive displacement supercharger with the bypass valve at least partially closed, and supplying air from an outlet of the positive displacement supercharger to the cylinder intake at a second pressure higher than the first pressure;
admitting the air at the second pressure into the cylinder and supplying fuel to the cylinder, compressing the air and the fuel with the piston, and combusting the air and fuel to release power to the piston and crankshaft; and
manipulating an excess air factor by controlling a position of the bypass valve.

16. The method of claim 15, wherein the input shaft of the positive displacement supercharger is driven by the crankshaft with an effective drive ratio of between about 1.9:1 and about 3.5:1.

17. The method of claim 15, wherein the excess air factor is maintained above 1.0 whenever the supercharger is operating to increase the pressure of air from the inlet of the positive displacement supercharger to the outlet of the positive displacement supercharger.

18. The method of claim 15, wherein the bypass valve is variably positionable between an open position configured to direct substantially all of the air from the turbocharger air outlet around and not through the positive displacement supercharger, and a closed position configured to direct substantially all of the air from the turbocharger air outlet through the positive displacement supercharger, the method further comprising determining a current excess air factor and moving the bypass valve toward the closed position when the current excess air factor is below a target excess air factor.

19. The method of claim 18, further comprising operating the engine in a non-supercharged HCCI combustion mode while maintaining the bypass valve in the open position from idle up to a threshold engine speed, and transitioning to a supercharged HCCI mode by moving the bypass valve toward the closed position when the threshold engine speed is exceeded.

20. The method of claim 19, further comprising decoupling the mechanical driving connection between the crankshaft and the input shaft of the positive displacement supercharger above an upper threshold engine speed, and operating the engine in a stoichiometric spark ignition combustion mode.
